(19) United States
(12) Patent Application Publication
(10) Pub. No.: US 2003/0054720 A1
(43) Pub. Date: Mar. 20, 2003

(54) Laminated sheet and its manufacturing

(76) Inventors: Hiroki Ohwada, Ichihara-shi (JP); Hidenori Hagio, Ichihara-shi (JP); Kazuhiko Masuda, Ichihara-shi (JP)

Correspondence Address: BIRCH STEWART KOLASCH & BIRCH, PO BOX 747, FALLS CHURCH, VA, 22040-0747, US

(21) Appl. No.: 10/235,543

(22) Filed: Sep. 6, 2002

(30) Foreign Application Priority Data
Sep. 7, 2001 (JP) 272521/2001
Sep. 7, 2001 (JP) 272530/2001

(51) Int. Cl. B32B 27/12; D04H 1/00; D04H 3/00; D04H 5/00; D04H 13/00

(52) U.S. Cl. 442/327

(57) ABSTRACT

A laminated sheet having cloth-like texture can be obtained with polymeric film constructed of at least two layers being laminated over a non-woven fabric, while part of the polymeric film layer contacting the non-woven fabric penetrates into spaces between the fibers of the non-woven fabric to integrate said members into a combined body. It is suitable for uses as packaging materials and personal hygiene products. All the polymeric film layers are formed from resin containing inorganic filler, and when the laminated sheet is subjected to a drawing process, the resulting laminated sheet imparts high water vapor transmission rate and high hydrostatic head. In case the polymeric film layer does not contain inorganic filler, laminated sheets having high stretch can be obtained.

### BACKGROUND OF THE INVENTION

1. Field of the Invention

The present invention relates to a laminated sheet which is formed by laminating a non-woven fabric and a polymeric film that has cloth-like texture and a method for manufacturing such a laminate sheet. More specifically, the present invention relates to a laminated sheet which has air permeability and liquid impermeability in addition to the cloth-like texture, or a cloth-like sheet having good stretch, and a method for manufacturing such a laminated sheet.

2. Description of the Background

Two-layered sheets have been manufactured by laminating thermoplastic polymeric film onto non-woven fabric. Such two-layered sheets have been utilized in a wide variety of industrial fields as packaging materials, personal hygiene products such as diapers, sanitary napkins, and construction and building materials such as waterproof sheets. The physical properties of these sheets have attracted attention of interested parties.

The reason for using the two-layered sheet is to make use of the properties inherent to the non-woven fabric and polymeric film, respectively. Extrusion lamination is widely used to produce the two-layered sheet due to its production stability and good economy. However, laminating thermoplastic resin onto the surface of non-woven fabric which has innumerous openings is apt to allow the molten resin to deeply penetrate into spaces between the fibers. As a result, the cloth-like texture inherent to the non-woven fabric is lost, and stretch of polymeric film is impaired, and pinholes tend to be formed in the polymeric film layer. For said reason, the properties of the respective layers are not effectively used. There is a recognized need to further enhance the physical properties of such sheet by improving the manufacturing method.

### SUMMARY OF THE INVENTION

Accordingly it is an object of the present invention to provide a laminated sheet which is water vapor permeable, liquid-impermeable, and retains cloth-like texture inherent to the non-woven fabric, and a method for manufacturing such a laminated sheet.

It is another object of the present invention to provide a laminated sheet having cloth-like texture inherent to the non-woven fabric, which additionally possess the stretch inherent to the polymeric film and a method for manufacturing such laminated sheet.

Other and further objects, features and advantages of the present invention will appear more fully from the following description.

The present invention relates to a laminated sheet, which comprises a laminate formed by joining at least two layers of polymeric film to a non-woven fabric, wherein part of the polymeric film layer contacting the non-woven fabric layer penetrates into spaces between the fibers of the non-woven fabric.

It is a preferred mode of embodiment of said laminated sheet, wherein the laminate is drawn at least in one direction and has hydrostatic head of 1,000 mm H₂O or more and water vapor transmission rate (WVTR) of 1,000 to 6,000 g/m²/24 hr.

There can be cited as another preferred mode of embodiment of said laminated sheet, wherein the laminate has an elongation at break of 200 to 1,000% in a transverse direction and a tensile strength of 5 to 30 N/cm in a transverse direction.

It is preferable that said non-woven fabric layer is a spunbonded non-woven fabric or a laminated non-woven fabric constructed of a spunbonded non-woven fabric and a melt-blown non-woven fabric, has its mass per unit area (hereinafter referred to as “basis weight”) of 10 to 60 g/m², and is produced from polyolefin, respectively.

It is preferable that said polymeric film layers have an overall basis weight of 10 to 60 g/m², while the basis weight of the polymeric film layer contacting said non-woven fabric layer included in said polymeric film layers is 5 to 50 g/m². As regards the resin constituting the polymeric film layers, at least one of its layers may contain inorganic filler. In such case, it is preferable that the inorganic filler content is in a range of 20 to 70% by weight. It is preferable that such polymeric film layers are produced from polyolefin, for which particularly preferred is polyolefin comprising an ethylene-α-olefin copolymer. It is preferable that the polymeric film layer contacting the non-woven fabric layer is produced from a polyolefin having a density of 0.870 to 0.935 g/cm³, a melt flow rate (MFR) of 1 to 90 g/10 min., and a melt tension (MT) of 0.5 to 10 g.

It is preferable that such laminate is drawn by 1.1 to 5 times in at least one direction.

The present invention relates to a method for manufacturing a laminated sheet, which comprises a first step in which a two-layered laminate is formed by extruding molten resin through a flat die at an temperature underneath the die of 200 to 280° C., onto a surface of a non-woven fabric and thereupon integrating the non-woven fabric layer and the polymeric film layer into a two-layered laminate by means of passing said two layers through a gap in a pair of rolls consisting of a nip roll and a chill roll under such condition that a nip pressure is controlled at 5 to 20 kg/cm², and a second step in which a laminate is formed by coating the same type or a different type of resin over said polymeric film layer.

The present invention furthermore relates to a method for manufacturing a laminated sheet, which comprises forming a laminate by integrating three layers by means of extruding molten resin through a flat die at an temperature underneath the die of 200 to 280 as an interlayer between a non-woven fabric and the same type or a different type of polymeric film and thereupon integrating all of those layers into a three-layered laminate by means of passing said three layers through a gap in a pair of rolls consisting of a nip roll and a chill roll under such condition that a nip pressure is controlled at 5 to 20 kg/cm².

It is preferable that the non-woven fabric is fed at tension of 0.1 to 5 kg/m in a machine direction. Said polymeric film layers may contain inorganic filler in at least one of its layers, and it is preferable that the inorganic filler content is in a range of 20 to 70% by weight. On top of aforesaid manufacturing method there may be further comprising a drawing step of the obtained laminate in at least one direction, in which case the drawing step is preferably executed by feeding the laminate to a gear stretch equipment.

Next, explanation is made on preferred modes of embodiment of the present invention in two parts as follows.

The first mode of embodiment relates to a laminated sheet, which comprises a laminate formed by joining at least two layers of polymeric film to a non-woven fabric, wherein the polymeric film layers are produced from resin containing inorganic filler and part of the polymeric film layer contacting the non-woven fabric layer penetrates into spaces between the fibers of the non-woven fabric.

It is preferable that aforesaid laminate is drawn in at least one direction and has hydrostatic head of 1,000 mm H₂O and a water vapor transmission rate (WVTR) of 1,000 to 6,000 g/m²/24 hr.

The preferred breakdown of the total thickness of the laminated sheet is 10 to 60 g/m² for the non-woven fabric layer and 10 to 60 g/m² for the polymeric film layers, while the thickness of the polymeric film layer contacting the non-woven fabric layer included in said polymeric film layers is 5 to 50 g/m².

Preferred types of non-woven fabric are spunbonded fabrics and laminated non-woven fabrics obtained by laminating a melt-blown non-woven fabric over a spunbonded non-woven fabric. It is preferable that both the non-woven fabric and the polymeric film are produced from polyolefin. In particular, suitable for the polymeric film layer to contact the non-woven fabric layer is a resin having a density of 0.870 to 0.935 (g/cm³), a melt flow rate (MFR) of 1 to 90 (g/10 min.), and a melt tension (MT) of 0.5 to 10 (g). One example of such resin is polyolefin comprising an ethylene-α-olefin copolymer. It is preferable that the resin constituting the polymeric film layers contains inorganic filler by 20 to 70% by weight.

The present invention also relates to a method for manufacturing a laminated sheet, which comprises of a first step in which a two-layer laminate is formed by extruding molten resin including inorganic filler through a flat die at temperature underneath the die of 200 to 280° C. onto a surface of a non-woven fabric, and thereupon integrating the non-woven fabric layer and the polymeric film layer into a two-layered laminate by means of passing said two layers through a gap in a pair of rolls consisting of a nip roll and a chill roll under such condition that a nip pressure is controlled at 5 to 20 kg/cm², and a second step in which a laminate is formed by coating a polymeric film layer produced from said resin containing an inorganic filler over said polymeric film layer. As to aforesaid first step, it is preferable that the non-woven fabric is fed at tension of 0.1 to 5 (kg/m) in machine direction.

According to the present invention, it is preferable that a gear stretch equipment be employed for the drawing step in complying with the method for manufacturing laminated sheet to which a third step further comprising to draw the laminate in at least one direction is added.

The second mode of embodiment of the present invention relates to a laminated sheet, which comprises a laminate formed by joining at least two layers of polymeric film to a non-woven fabric, wherein part of its polymeric film layer contacting the non-woven fabric layer penetrates into spaces between the fibers of the non-woven fabric, and has an elongation at break of 200 to 1,000% in a transverse direction of the laminate and a tensile strength of 5 to 30 N/cm in a transverse direction.

The preferred breakdown of the total thickness of the laminated sheet is 10 to 60 g/m² for the non-woven fabric layer and30 to60 g/m²for the polymeric film layers, while a thickness of the polymeric film layer contacting the non-woven fabric layer included in said polymeric film layers is 5 to 40 g/m².

Preferred types of non-woven fabric are spunbonded non-woven fabrics or laminated non-woven fabrics obtained by laminating a melt-blown non-woven fabric over a spunbonded non-woven fabric. It is preferable that both the non-woven fabric and the polymeric film are produced from polyolefin. Particularly preferred for the polymeric film layer contacting the non-woven fabric layer is a resin having a density of 0.870 to 0.935 g/cm³, a melt flow rate (MFR) of 1 to 90 g/10 min., and a melt tension (MT) of 0.1 to 10 g. One example is polyolefin comprising an ethylene-α-olefin copolymer. It is preferable that at least one among all layers of the polymeric film layers excluding the first layer is produced from a resin containing inorganic filler by 20 to 70% by weight.

The present invention also relates to a method for manufacturing a laminated sheet, whose elongation at break is 200 to 1,000% in its transverse direction and tensile strength is 5 to 30 N/cm in its transverse direction, comprising a first step in which a two-layered laminate is formed by extruding molten resin through a flat die at temperature underneath the die of 200 to 280° C. onto a non-woven fabric and thereupon integrating the non-woven fabric layer and the polymeric film layer into a two-layered laminate by means of passing aforesaid two layers through a gap in a pair of rolls consisting of a nip roll and a chill roll under such condition that a nip pressure is controlled at 5 to 20 kg/cm², and a second step in which a laminate is formed by coating another polymeric film layer over aforesaid polymeric film layer.

As to aforesaid first step, it is preferable that the non-woven fabric is fed at tension of 0.1 to 5 (kg/m) in a machine direction. As to aforesaid second step, it is preferable that the extrusion lamination is executed using the same type of resin as used in the first step. It is furthermore preferable that at least one layer among aforesaid polymeric film layers is produced from a resin containing inorganic filler at 20 to 70% by weight.

### DETAILED DESCRIPTION OF THE PREFERRED EMBODIMENTS

The present invention is explained in detail in the sequence of a structure of laminate and manufacturing steps as follows.

### Laminated Sheet

The laminated sheet of the present invention has the structure of a laminate in which a non-woven fabric is joined to a polymeric film constructed of at least two layers and part of the polymeric film layer contacting the non-woven fabric layer penetrates into spaces between the fibers of the non-woven fabric to combine the two layers into an integrated body.

The thickness of the respective layers expressed in terms of the mass per unit area, namely, basis weight, are preferably 10 to 60 g/m², and more preferably 15 to 40 g/m²for the non-woven fabric layer and preferably 10 to 60 g/m²and more preferably 15 to 55 g/m² for the polymeric film layers as a whole. Insofar as the thicknesses of the respective layers stand within aforesaid ranges any resulting sheet imparts sufficient mechanical strength required of a sheet to serve normal uses, exhibits cloth-like texture in the form of a thin and soft sheet, imparts good hydrostatic head and air permeability, and imparts comfortable fit for other object.

Meanwhile, the polymeric film layers are constructed of at least two layers of which the layer contacting the non-woven fabric layer has a basis weight of preferably 5 to 50 g/m², and more preferably 5 to 35 g/m², and furthermore preferably 10 to 25 g/m². Insofar as the total thickness of the polymeric film layers and the breakdown by all layers stand within aforesaid ranges the resulting sheet imparts enhanced flexibility and stretch as a laminated sheet and enhanced cloth-like texture inherent to the non-woven fabric by itself, such as soft, lofty touch.

It is an essential consideration for the laminated sheet of the present invention that the required thickness of the resin layers is fulfilled by separately forming two or more layers. In this connection, it is preferable that the first polymeric film layer contacting the non-woven fabric layer is made as thin as possible to the extent that its thickness is either equivalent to or thinner than that of the second and any ensuing polymeric film layer(s). So long as the required thickness of the polymeric film layer is fulfilled by a single layer alone, the obtained laminated sheet is stiff and can hardly have flexibility and cloth-like texture.

Usable as the non-woven fabric is any non-woven fabric produced from short fiber, long fiber or continuous filament. Usable types of raw material are polyolefin such as polyethylene and polypropylene, polyester such as poly(ethylene terephthalate), polyamide such as nylon-6 and nylon-6,6, and there is no particular limitation to the choice of said materials. Conjugate fibers (bicomponent fibers) of the sheath and core type or the side-by-side type produced from polyethylene or polypropylene are usable, too. Fiber-to-fiber bond may be achieved either by heat bonding or by adhesive.

Usable for aforesaid purpose are non-woven fabrics manufactured in accordance with a dry process, a wet process, a spunbond process or a melt-blown process. Above all, non-woven fabrics manufactured from polypropylene in accordance with the spunbond process or laminated non-woven fabrics obtained by laminating the melt-blown non-woven fabric onto the spunbonded non-woven fabric are suitable for the manufacture of the laminated sheet used for packaging materials and personal hygiene applications due to their properties, i.e. high tensile strength and a high water vapor transmission rate and, furthermore, hydrophobic characteristic.

The polymeric film layers are produced from thermoplastic synthetic resin such as polyolefin. The polyolefin may be an olefin homopolymer or a copolymer produced from olefin and a comonomer. Furthermore, it may be a blend of said two materials. There is no particular limitation to the choice of said materials. There can be cited as examples of usable resins polyethylene, polypropylene, ethylene-vinyl acetate copolymer and ethylene-methacrylic acid copolymer. Among the cited materials, a resin adaptive to good adhesion with non-woven fabric is preferred.

It is preferable that the polymeric film layer to contact the non-woven fabric layer is produced from a polyolefin resin which falls in the following respective ranges of density, melt flow rate (MFR), and melt tension (MT). The density range is preferably 0.870 to 0.935 (g/cm³), or more preferably 0.870 to 0.920 (g/cm³), or furthermore preferably 0.870 to 0.910 (g/cm³). The range of MFR as measured at a temperature of 190° C. and under a load of 2.16 kg in accordance with ASTM D-1238 is preferably 1 to 90 (g/10 min.),or more preferably 3 to 35 (g/10 min.). The MT range is preferably 0.1 to 10 (g), more preferably 0.5 to 10 (g), or furthermore preferably 0.5 to 8 (g). Polyolefin resin falling in said ranges of physical properties exhibits good extrusion lamination processability by its adequate melt viscosity, and imparts flexibility to the obtained laminated sheet.

Melt tension (MT) as referred to in this connection conforms values determined using a melt tension testing apparatus (manufactured by Toyo Precision Machine Manufacturing Company) under conditions of a nozzle diameter of 2.09 mm, a nozzle length of 8 mm, a resin temperature of 190° C., an extrusion speed of 15 m/min., and a take-up speed of 10 to 20 m/min.

One example of such preferred polyolefin is a resin fulfilling said physical properties which is a copolymer produced from ethylene and an α-olefin having 3 to 20 carbon atoms, the latter of which being contained by 0.1 to 10 mol. %. As examples of such α-olefin, there can be cited propylene, 1-butene, 4-methyl-1-pentene, 1-hexene, and 1-octene. The copolymer maybe blended with high pressure-method low density polyethylene or elastomers. Insofar as such polyolefin is used, laminated sheets having high elongation at break and high tensile strength may be readily produced.

It is a requisite condition for the present invention that the polymeric film layers are comprised of at least two layers. A kind of resin to constitute the layers may be the same type or of different types with each other. It is, however, preferable that such combination be adopted that achieves strong adhesion to each other. The polymeric film layer to contact the non-woven fabric layer is produced from polyethylene, particularly the ethylene-α-olefin copolymer with a view to achieving good adhesion to the non-woven fabric layer and flexibility which is a requisite condition for the laminated sheet. It is preferable that the polymeric film layer to constitute a second layer and the ensuing layer(s), (if there is any such layer) be produced from polyethylene likewise since such polyethylene gives good adhesion to each other.

The resin that constitutes the polymeric film layers may or may not contain inorganic filler. In order to obtain polymeric film having good air permeability and high hydrostatic head, it is desirable that all polymeric film layers contain inorganic filler because high air permeability may be achieved along with the drawing process which will be mentioned later. In cases where polymeric film having good stretch are to be obtained, inorganic filler is not necessarily contained.

As the usable inorganic filler, such inorganic substance conventionally used as an additive in the plastic industry as silica, calcium carbonate and magnesium hydroxide may be used. Such inorganic filler may be contained in the resin at preferably 20 to 70% by weight, and more preferably 50 to 65% by weight. So long as inorganic filler is contained by a quantity falling in said ranges, the resulting laminated sheet gives a soft touch and the rattle noise made when the laminated sheet is handled, is eliminated.

In cases where high air permeability is sought for the laminated sheet, it is preferable that the laminate as a whole is drawn at least in one direction and preferably in the transverse direction, additionally to the mode of layer composition as explained in the foregoing. The drawing ratio is preferably 1.1 to 5 times, and more preferably 1.1 to 3 times. It is by means of such drawing treatment that the laminated sheet may have its air permeability increased and may acquire flexibility. The laminate as a whole may be drawn in both the machine and transverse directions. It is not a requisite condition that the drawing be made evenly in both directions. For instance, it may be drawn more intensively in the transverse direction and less intensively in the machine direction. For the purpose of defining the direction as referred to herein, the direction to which the in-process laminated sheet is forwarded along the flow of fabrication is defined to be “machine direction” and the direction assuming a right angle to the machine direction is defined to be “transverse direction”.

The polymer phase and the inorganic filler phase are separated within the polymeric film layer that contains inorganic filler by this drawing process. Inconsequence, innumerous micro voids are formed. It is inferred that interconnection of these voids gives air permeability of the polymeric film layer containing such voids.

There can be cited as a mode of embodiment of this laminated sheet a sheet having hydrostatic head of preferably 1,000 mm H₂O or more and a water vapor transmission rate of 1,000 to 6,000 g/m²/24 hr, and more preferably 2,500 to 6,000 g/m²/24 hr. Such laminated sheet possesses liquid impermeability while retaining air permeability.

The hydrostatic head as used herein conforms to the value determined in accordance with JIS-L1092 (Method A) and the water vapor transmission rate (WVTR) conforms to that of ASTM E-96. Typically, a laminate constructed of non-woven fabric and one layer of polymeric film has its hydrostatic head deteriorated upon formation of pinholes. Nevertheless, in the present invention, liquid impermeability and air permeability that are mutually contradicting properties of the laminated sheet may be enhanced as the result of the adoption of the two-layer structure for the polymeric film.

Said laminated sheet is suitable for uses as packaging materials and personal hygiene products, because it possesses both liquid impermeability and air permeability and also it, being a relatively thin sheet, possesses cloth-like texture and flexibility as is obviously seen from said thickness of the laminate. In particular, the laminated sheet of the present invention is suitable typically for the outer cover of diaper that requires high hydrostatic head and high water vapor transmission rate.

As another mode of embodiment of the laminated sheet, there can be cited a sheet having an elongation at break of preferably 200 to 1,000% in the transverse direction as determined by a tensile test, and more preferably 300 to 900%, and a tensile strength of 5 to 30 N/cm, and more preferably 8 to 25 N/cm in the transverse direction.

The aforesaid tensile test was performed on 25 mm-wide specimens using Model 1201 tensile tester manufactured by INTESCO Company under conditions of a gage length of 100 mm and across head speed of 100 mm/min. For the purpose of defining the direction, the flow direction of the laminated sheet fabrication is defined to be “machine direction” and the direction assuming a right angle to the machine direction is defined to be “transverse direction”.

Insofar as the elongation at break and tensile strength remain within said ranges, the cloth-like texture inherent to the non-woven fabric which is expressed by such terms as soft touch, loftiness remains intact in the laminated sheet, and stretch inherent to the polymeric film also remains in the laminated sheet. In cases where a polymeric film layer is formed with only one layer in order to achieve the same thickness as that of the polymeric film layers of the present invention, which are formed with at least two layers, the elongation at break of such laminated sheet falls short of the said range, and consequently cloth-like texture cannot be achieved.

Because such laminated sheet is relatively thin as can be obviously seen from said requisite thickness ranges and imparts cloth-like texture and flexibility, it is suitable for uses as packaging materials and personal hygiene products. It is particularly suitable for the stretch materials of diaper that require high elongation at break and high tensile strength.

### Method for Manufacturing Laminated Sheet

The first method for manufacturing the laminated sheet of the present invention comprises a first step in which a laminate is formed by extruding molten resin onto a non-woven fabric layer and thereupon passing said two layers through a gap in a pair of rolls consisting of a nip roll and a chill roll, and a second step in which another resin layer is coated over said resin layer.

The laminator utilized to manufacture the laminate is comprised basically of at least an extruder equipped with a flat die or T-die and a pair of rolls consisting of a chill roll and a nip roll. It is preferable that the non-woven fabric fed to the laminator substantially free of tension in the machine direction, preferably under a tension of 0.1 to 5 kg/m. Insofar as the non-woven fabric is fed to the laminator virtually free of tension as such, wrinkles do not occur in the non-woven fabric layer of the laminated sheet and the obtained laminated sheet exhibits good appearance.

It is preferable that the temperature of the molten resin extruded through the flat die is controlled at within the range of 200 to 280° C., and preferably 200 to 250° C. as measured in the molten resin immediately outside of the die, that is to say, temperature underneath the die. The temperature is to be controlled at somewhat lower than the resin temperature that applies to typical extrusion lamination operation. Insofar as the temperature underneath the die stays within said ranges, the obtained laminated sheet retains the cloth-like texture inherent to the non-woven fabric.

The non-woven fabric and the molten resin layer extruded onto the surface of the non-woven fabric layer are subsequently forwarded to the gap in a pair of rolls consisting of a chill roll and a nip roll, and the two layers are combined under a nip pressure into an integrated body and thus formed into a cooled laminate. The nip pressure is controlled at a level where the molten resin penetrates slightly into the non-woven fabric layer. Specifically, the nip pressure is controlled at 5 to 20 kg/cm², and preferably 7 to 18 kg/cm². Even though the nip pressure is controlled at within such a low pressure, the non-woven fabric layer and the polymeric film layers are joined to each other into an integrated body with no pinholes in the polymeric film layers, and the resulting laminate retains the cloth-like texture inherent to the non-woven fabric.

Thereupon, the manufacturing operation proceeds to a second step in which a second polymeric film layer is coated over the surface of the first polymeric film layer which has been formed on the surface of the non-woven fabric layer in the previous step. The polymeric film layer which is to provide an additional coat may be a film of the same type as the first polymeric film layer or may be of a different material, and said thermoplastic resin such as polyolefin may be used. Said second step may be executed according to either the extrusion lamination in the same manner as in the previous step, or a process to laminate a preformed film directly onto the first polymeric film layer, for example, adhesive lamination. In case of the extrusion lamination, for which the same resin as used for the first polymeric film layer is used, laminated sheets having good physical properties may be manufactured at high productivity rates.

The second method for manufacturing the laminated sheet of the present invention comprises extruding as an interlayer between a non-woven fabric and a polymeric film molten resin of the same type as said resin or a different type of resin to form a laminate by directly combining the three layers into an integrated body. In executing said manufacturing method, such operating conditions may be adopted that the molten resin be extruded through a flat die at an temperature underneath the die of 200 to 280° C., and preferably 200 to 250° C., and thereupon said three layers be passed through a gap in a pair of rolls consisting of a nip roll and a chill roll under a nip pressure of 5 to 20 kg/cm² and preferably 7 to 18 kg/cm² cm. Even if said method is employed, it is preferable that the non-woven fabric be forwarded to the machine under substantially no tension applied thereto in the machine direction, under the tension adjusted preferably to 0.1 to 5 kg/m.

The laminate thus obtained is, insofar as necessary, sent to a drawing or stretching process wherein the laminate is drawn in at least one direction. This drawing process gives the laminated sheet air permeability

The drawing equipment may be of the conventional type for drawing or stretching the laminate in the machine and/or transverse direction(s), or so-called ‘gear stretch equipment’. The ratio of drawing is preferably 1.1 to 5 times, and more preferably 1.1 to 3 times. The drawing may be executed successively after each method in the laminate manufacture, or may be executed independently after the laminate manufacture has been completed.

The gear stretch equipment is composed of a pair of intermeshing rolls on whose surfaces are disposed and fixed at even intervals large numbers of disks. The each roll rotates in opposite directions, and the disks are so designed that they are set at certain depths sufficient to keep them from contacting their opposite disks while in motion. When the laminate is fed into the gap in the rolls, the laminate is caught into the troughs between the disks on one roll and the disks on the other, while the disks on the two rolls rotate in opposite directions. The laminate while it is being caught between the rolls is drawn in the transverse and/or machine direction(s). When this gear stretch equipment is operated, the laminate is drawn principally in the transverse direction. However, by means of varying conditions of the equipment, such as the configuration, the depth, etc. of the gear, and operating conditions such as the laminate feeding speed and the roll rotation speed, etc., the ratio of drawing for the laminate in the respective directions can be controlled.

According to the present invention, the first polymeric film layer is formed under the aforementioned extrusion lamination conditions and the polymeric film layers of the second and ensuing layer(s) are coated over the first polymeric film layer. The consequence of said fabrication steps is that the requisite thickness of the polymeric film layer is achieved via two or more stages of film formation. It is inferred that said fabrication step contributes to development of the liquid impermeability and cloth-like texture. Microscopic observations of the cross section of the laminated sheet reveals that the resin constituting the first polymeric film layer penetrates the non-woven fabric layer only to a shallow depth. Because of such slight penetration, the cloth-like texture of the non-woven fabric layer, can be retained in the laminated sheet. Moreover, the second and ensuing polymeric film layer(s) serve to prevent formation of pinholes. All of these effects combined are considered to enhance the liquid impermeability of the laminated sheet.

On the contrary, it has been verified through microscopic observations that in cases where the polymeric film layer having the same thickness is formed on the surface of the non-woven fabric in a one-step extrusion lamination, the molten resin penetrates into the non-woven fabric deeply. The laminated sheet thus obtained becomes stiff and does not retain the cloth-like texture, also shows low hydrostatic head.

### EXAMPLES

The present invention will be understood more readily with reference to the following examples; however, these examples are intended to illustrate the present invention and are not to be construed to limit the scope of the invention.

### Example 1

For a non-woven fabric, a spunbonded non-woven fabric having a basis weight of 20 g/m² and a width of 500 mm was formed from 2-denier continuous polypropylene filaments which were fixed by heat spot bonding.

For the resin to form the polymeric film layer, a resin composition consisting of 40% by weight of ethylene-4-methyle-1-pentene copolymer (density: 0.915 g/cm³; MFR: 20 g/10 min.; MT: 1.8 g) and 60% by weight of calcium carbonate was prepared.

Said resin composition was fed to an extruder having a 800 mm-wide flat die and a 65 mm-diameter screw, and was extruded at an temperature underneath the die of 250° C. and the extruded resin was coated over the surface of the continuously supplied non-woven fabric. During said operation, the tension applied to the non-woven fabric was 3 kg/m.

Next, the two-layered article was fed into the gap in a pair of rolls having a 900 mm width consisting of a chill roll maintained at a temperature of 20° C. and a nip roll and processed at a speed of 50 m/min., and thus was produced a laminate. During the operation the nip pressure was adjusted to 15 kg/cm². The basis weight of the polymeric film layer was 15 g/m².

Thereupon, said laminate was fed to a laminator of the same specifications as mentioned above, and the same resin composition was extrusion laminated onto the polymeric film layer to form a second polymeric film layer with the basis weight controlled to 15 g/m².

Next, the laminate was passed through a gear stretch equipment so as to achieve drawing by 1.6 times in the transverse direction and 1.1 times in the machine direction. The gear stretch equipment had a disk thickness of 0.762 mm, a disk clearance of 0.537 mm, a gear roll diameter of 152 mm, a gear roll width of 350 mm, and a depth of engagement of 3 mm.

Physical properties of the obtained laminated sheet are shown in Table 1.

The number of pinholes as indicated in Table 1 was counted as follows. That is to say, after causing colored water to infiltrate the laminate from the film layer side under a pressure of 50 mm H₂O, the number of spots thereby stained on the non-woven fabric side was counted.

### Comparative Example 1

The same procedure as in Example 1 was followed except that the extrusion lamination was executed so as to control the first polymeric film layer to a basis weight of 30 g/m² and there was not formed a second polymeric film layer as in Example 1. Physical properties of the obtained laminated sheet are shown alongside in Table 1.

### Comparative Examples 2 and 3

A laminated sheet was formed according to the same procedure as followed in Example 1 except that the temperature underneath the die and the nip pressure as applied in Example 1 were changed to the ones indicated in Table 1. Physical properties of the obtained laminated sheet are shown alongside in Table 1.

TABLE 1

| | | Compara. | Compara. | Compara. |
|---|---|---|---|---|
| | Example 1 | Example 1 | Example 2 | Example 3 |
| Number of | 2 | 1 | 2 | 3 |
| polymeric film | | | | |
| layers | | | | |
| Forming | | | | |
| conditions | | | | |
| Temp. | 250 | 250 | 285 | 285 |
| underneath | | | | |
| the die (° C.) | | | | |
| Nip pressure | 15 | 15 | 15 | 24 |
| (kg/cm²) | | | | |
| Physical | | | | |
| properties of | | | | |
| the laminated | | | | |
| sheet | | | | |
| Hydrostatic | >2000 | 50 * | 50 | 50 |
| head | | | | |
| (mm H₂O) | | | | |
| Water vapor | | | | |
| Transmission | 4220 | 1530 ** | *** | *** |
| rate | | | | |
| (g/m²/24 hr) | | | | |
| Nr. of | 0 | 10 | >20 | >20 |
| pinholes | | | | |
| (N/m²) | | | | |
| Softness of | Good | Not so | Bad | Bad |
| the non- | | good | | |
| woven side | | | | |
| Loftiness of | Good | Bad | Bad | Bad |
| the non- | | | | |
| woven side | | | | |

* In the area with pinholes
** In the area without pinholes
*** unable to measue

### Example 2

For a non-woven fabric, a spunbonded non-woven fabric having a basis weight of 23 g/m² and a width of 500 mm was formed from 2-denier continuous polypropylene filaments which were fixed by heat spot bonding. This non-woven fabric had an elongation at break of 40% in the transverse direction and a tensile strength of 3 N/cm in the transverse direction.

For the resin to form the polymeric film layer, a resin composition consisting of ethylene-1-hexene copolymer (density: 0.900 g/cm³; MFR: 9 g/10 min.; MT: 2 g) was prepared. The film which was formed from said resin had a thickness of 55 μm and its elongation at break was 700% in the transverse direction.

Said resin composition was fed to an extruder having a 800 mm-wide flat die and a 65 mm-diameter screw, and was extruded at an temperature underneath the die of 250° C. and the extruded resin was coated over the surface of the continuously supplied non-woven fabric. During said operation, the tension applied to the non-woven fabric was 3 kg/m.

Next, the two-layered article was fed into the gap of a pair of rolls having a 900 mm width consisting of a chill roll maintained at a temperature of 20° C. and a nip roll and processed at a speed of 50 m/min., and thus was produced a laminate. During the operation the nip pressure was adjusted to 15 kg/cm². The basis weight of the polymeric film layer was 25 g/m².

Thereupon, said laminate was fed to a laminator of the same specifications as mentioned above, and the same resin composition was extrusion laminated onto the polymeric film layer toform a second polymeric film layer with the basis weight of 30 g/m². Physical properties of the obtained laminated sheet are shown in Table 1.

### Comparative Example 4

A laminated sheet was formed according to the same procedure as followed in Example 1 except that the extrusion lamination was executed so as to make the basis weight of the first polymeric film layer 55 g/m², and there was not formed a second polymeric film layer as in Example 1. Physical properties of the obtained laminated sheet are shown alongside in Table 1.

### Comparative Example 5

A laminated sheet was formed according to the same procedure as followed in Example 1 except that the temperature underneath the die was changed to 285° C. Physical properties of the obtained laminated sheet are shown alongside in Table 1.

TABLE 2

| | | Compara. | Compara. |
|---|---|---|---|
| | Example 3 | Example 4 | Example 5 |
| Number of polymeric film | 2 | 1 | 2 |
| layers | | | |
| Forming Condition | | | |
| Temperature underneath | 250 | 250 | 285 |
| the die (° C.) | | | |
| Nip pressure (kg/cm²) | 15 | 15 | 15 |
| Physical properties of the | | | |
| laminated sheet | | | |
| Elongation at break (%) | 450 | 70 | 50 |
| Tensile strength (N/cm) | 8.3 | 9.0 | 8.0 |
| Softness of the | Good | Bad | Bad |
| non-woven side | | | |
| Loftiness of the | Good | Bad | Bad |
| non-woven side | | | |

### Effect of the Invention

The laminated sheet of the present invention which is comprised of a non-woven fabric layer and polymeric film layers retains cloth-like texture. This laminated film additionally possesses high liquid impermeability and, at the same time, air permeability. The laminated sheet of the present invention is suitable for liquid impermeable applications for which cloth-like texture is required, particularly for uses as packaging materials and personal hygiene products. Moreover, laminated sheets having such high stretch inherent to the polymeric film may be obtained. Owing to said characteristics it may be utilized as packaging materials or personal hygiene products for which high tensile strength and high elongation are required.

According to the method for manufacturing the laminated sheet of the present invention, the laminated sheet having aforesaid properties may be manufactured at high productivity rates.

What we claim is:

1. A laminated sheet, which comprises a laminate formed by joining at least two layers of polymeric film to a non-woven fabric, wherein part of the polymeric film layer contacting the non-woven fabric layer penetrates into spaces between the fibers of the non-woven fabric.

2. A laminated sheet according to claim 1, wherein said laminate is drawn in at least one direction and has hydrostatic head of 1,000 mm H₂O or more and a water vapor transmission rate of 1,000 to 6,000 g/m²/24 hr.

3. A laminated sheet according to claim 1, wherein said laminate has an elongation at break in a transverse direction falling in a range of 200 to 1,000% and a tensile strength in a transverse direction falling in a range of 5 to 30 N/cm.

4. A laminated sheet according to either one of claims 1 to 3, wherein said non-woven fabric layer has a basis weight falling in a range of 10 to 60 g/m².

5. A laminated sheet according to either one of claims 1 to 4, wherein said non-woven fabric layer is a spunbonded non-woven fabric or a laminated non-woven fabric obtained by combining such spunbonded fabric with a melt-blown non-woven fabric.

6. A laminated sheet according to either one of claims 1 to 5, wherein said non-woven fabric layer is formed from polyolefin.

7. A laminated sheet according to either one of claims 1 to 6, wherein said polymeric film layers have an overall basis weight falling in a range of 10 to 60 g/m².

8. A laminated sheet according to either one of claims 1 to 7, wherein the polymeric film layer contacting said non-woven fabric layer has a basis weight falling in a range of 5 to 50 g/m².

9. A laminated sheet according to either one of claims 1 to 8, wherein at least one layer in said polymeric film layers is formed from a resin containing inorganic filler.

10. A laminated sheet according to claim 9, wherein said inorganic filler is contained in a range of 20 to 70% by weight.

11. A laminated sheet according to either one of claims 1 to 10, wherein said polymeric film layers are formed from polyolefin.

12. A laminated sheet according to claim 11, wherein said polyolefin comprises an ethylene-α-olefin copolymer.

13. A laminated sheet according to either one of claims 1 to 12, wherein the polymeric film layer contacting said non-woven fabric layer is formed from polyolefin having a density of 0.870 to 0.935 g/cm³, a melt flow rate of 1 to 90 g/10 min., and a melt tension of 0.5 to 10 g.

14. A laminated sheet according to either one of claims 1 to 13, wherein said laminate is drawn by 1.1 to 5 times in at least one direction.

15. A method for manufacturing a laminated sheet, which comprises of a first step in which a two-layered laminate is formed by extruding molten resin through a flat die at an temperature underneath the die of 200 to 280° C. onto a surface of a non-woven fabric and thereupon integrating the non-woven fabric layer and the polymeric film layer into a two-layered laminate by means of passing said two layers through a gap in a pair of rolls consisting of a nip roll and a chill roll under such condition that a nip roll pressure is controlled at 5 to 20 kg/cm², and a second step in which a laminate is formed by coating a same type or a different type of resin over said polymeric film layer.

16. A method for manufacturing a laminated sheet, which comprises forming of a laminate by integrating three layers by mans of extruding molten resin through a flat die at an temperature underneath the die of 200 to 280° C. as an interlayer between a non-woven fabric and the same type or a different type of polymeric film and thereupon integrating all of those layers into a three-layered laminate by means of passing said three layers through a gap in a pair of rolls consisting of a nip roll and a chill roll under such condition that a nip pressure is controlled at 5 to 20 kg/cm².

17. A method for manufacturing a laminated sheet according to claim 15 or claim 16, wherein said non-woven fabric is fed at tension of 0.1 to 5 kg/m in a machine direction.

18. A method for manufacturing a laminated sheet according to either one of claims 15 to 17, wherein at least one layer in said polymeric film layers contains inorganic filler.

19. A method for manufacturing a laminated sheet according to either one of claims 15 to 17, wherein at least one layer in said polymeric film layers contains 20 to 70% by weight of inorganic filler.

20. A method for manufacturing a laminated sheet, which is further comprising a drawing step of the laminate as obtained by the method of either one of claims 15 to 19 at least in one direction.

21. A method for manufacturing a laminated sheet according to claim 20, wherein said drawing step is executed by feeding the laminate to a gear stretch equipment.
